(19) United States
(12) Patent Application Publication
(10) Pub. No.: US 2024/0377292 A1
(43) Pub. Date: Nov. 14, 2024

(54) CLEARING AND EXPANSION METHOD AND IMAGING METHOD FOR BIOLOGICAL TISSUE

(71) Applicant: WESTLAKE UNIVERSITY, Hangzhou, Zhejiang (CN)

(72) Inventors: Liang GAO, Hangzhou, Zhejiang (CN); Yanlu CHEN, Hangzhou, Zhejiang (CN); Jing LU, Hangzhou, Zhejiang (CN); Ruili FENG, Hangzhou, Zhejiang (CN)

(21) Appl. No.: 18/688,650

(22) PCT Filed: Mar. 9, 2022
(86) PCT No.: PCT/CN2022/079854

§ 371 Date: Mar. 1, 2024

(30) Foreign Application Priority Data
Sep. 1, 2021 (CN) 202111019944.X

(51) Int. Cl. G01N 1/30; G01N 1/36; G01N 21/64

(52) U.S. Cl. CPC G01N 1/30; G01N 1/36; G01N 21/6428; G01N 21/6456; G01N 2021/6439

(57) ABSTRACT

Provided are a clearing and expansion method and an imaging method for biological tissue. The clearing and expansion method for biological tissue comprises: (1) degreasing a fixed biological tissue sample; (2) soaking the degreased biological tissue sample in a solution of gel monomer molecules, such that the monomer molecules permeate into the degreased biological tissue sample; (3) inducing a polymerization reaction of the monomer molecules permeating into the biological tissue sample so as to form a polymer gel; and (4) placing the biological tissue sample which has been subjected to a gelation treatment into water for expansion. The clearing and expansion method for biological tissue avoids the sample treatment steps of heating and enzymatic digestion that cause fluorescent quenching and the destruction of biological tissue, and thus has the advantages of high retention of endogenous fluorescent proteins, high mechanical strength of expanded biological tissue, a short sample treatment time, etc. Moreover, the advantage of an adjustable expansion ratio is further achieved by means of changing the components of a monomer reagent.

### TECHNICAL FIELD

The invention relates to the technical field of biological tissue clearing, and in particular to a clearing and expansion method and an imaging method for biological tissues.

### BACKGROUND

It is of great importance to use fluorescence microscopy in high-resolution three-dimensional imaging of multicellular biological tissues at submicron to nanometer level spatial resolution in terms of cell morphology, protein distribution, and gene expression.

However, it is very difficult to perform high-resolution three-dimensional fluorescence imaging on biological tissues. First, as most biological tissues are opaque, fluorescence microscopes can usually only image biological tissues within a depth of tens of microns below the surface of the tissue, which doesn't meet the need for three-dimensional imaging of the entire biological tissues. Secondly, due to the optical diffraction limit, traditional fluorescence microscopes can only achieve micron to sub-micron spatial resolution, while fluorescence microscopes that can achieve nanoscale super-diffraction resolution usually only have two-dimensional imaging capabilities, or can only achieve three-dimensional imaging on a single-cell sample with a thickness of several microns. Therefore, traditional fluorescence microscopy imaging technologies cannot meet the demand for three-dimensional imaging of large-volume, multi-cellular biological tissues at high spatial resolution of submicron to nanometer levels.

Hydrogel-based tissue expansion technology provides a new solution for high-resolution three-dimensional imaging on biological tissues {Chen, 2015}. The basic principle of hydrogel-based biological tissue expansion technology is that the protein molecules within the biological tissue to be imaged are cross-linked to the framework structure composed of hydrogel polymer molecules, and then the framework structure of the hydrogel polymer undergoes isotropic expansion to increase the spatial distance between the protein molecules cross-linked to the polymer framework. The effect is equivalent to increasing the physical size of the three-dimensional structure of the biological tissue corresponding to the protein molecules cross-linked to the polymer. At the same time, as other molecules in the biological tissue are removed and replaced by hydrogel molecules, the biological tissue expands and becomes transparent. Therefore, tissue expansion technologies not only allows the fluorescence microscope to perform three-dimensional imaging on the expanded transparent biological tissue, but also allows the microscope to obtain an imaging spatial resolution higher than the optical resolution of the fluorescence microscope itself during imaging due to the expansion of the three-dimensional structure of the biological tissue. It greatly reduces the difficulty in three-dimensional imaging on multicellular biological tissues by using fluorescence microscopy at high spatial resolutions of submicron to nanometer levels.

In the original hydrogel-based biological tissue expansion technology, the imaging resolution could exceed the optical spatial resolution of ˜200 nanometers of fluorescence microscopes and reach the actual imaging spatial resolution of ˜50 nanometers by covalently binding of biological tissue protein molecules to acrylamide monomer molecules, and performing gel polymerization and expansion of acrylamide monomer molecules to increase the spatial distance of labeled fluorescent protein molecules in biological tissues. Since then, several laboratories have developed more biological tissue expansion technologies by using different biological tissue processing procedures and gel monomer molecules, such as ProExM {Tillberg, 2016}, MAP {Ku, 2016}, ExFISH {Chen, 2016}, iExM {Chang, 2017}, SHIELD {Park, 2018}, CUBIC-X {Murakami, 2018}. By using these biological tissue expansion technologies, different types of biological tissues can be expanded at different ratios, such that traditional microscopes can be used to perform three-dimensional fluorescence imaging on various biological tissues at resolutions ranging from submicron to nanometer levels.

However, existing biological tissue expansion technologies have some common problems. First, most existing biological tissue expansion technologies require a protein denaturation procedure of the tissue, such as heating or enzymatic digestion, to ensure that the biological tissue after gelation can expand isotropically and uniformly. However, these protein denaturation methods may easily cause damage to endogenous fluorescent protein molecules that label the biological tissues, resulting in fluorescence quenching, making three-dimensional fluorescence imaging on expanded biological tissues extremely difficult. Second, the mechanical strength of the biological tissues is usually significantly reduced after expansion by the existing biological tissue expansion technologies, so that the expanded biological tissues are easily damaged, which makes it very difficult to image the expanded biological sample using conventional fluorescence microscopes, thereby greatly hindering three-dimensional imaging on the expanded biological tissue. In addition, most biological tissue expansion techniques can only expand biological tissues at a fixed ratio, and therefore cannot adjust the expansion ratio of a sample according to the imaging capability of the imaging system and the actual demand for imaging resolutions. Finally, the entire tissue expansion preparation process of most existing biological tissue expansion technologies often lasts several weeks, or even longer. These shortcomings severely limit the throughput of biological tissue expansion technologies in life sciences.

Therefore, a more rapid tissue clearing and expansion method is desired.

### SUMMARY OF THE INVENTION

Existing transparent tissue expansion technologies usually consist of multiple steps, including tissue fixation, monomer incubation, polymerization, embedding, protein denaturation, tissue expansion, and immunofluorescence staining (optional). The process has significant disadvantages. First, a fixed fresh biological tissue has a dense structure, so that the permeation efficiency of gel monomer molecules is very low. It takes longer time for the monomer molecules to permeate into the biological tissue evenly. Second, the protein denaturation after monomer polymerization is usually completed by methods such as heating or enzymatic digestion. These protein denaturation methods not only quench endogenous fluorescent proteins, but also affect the mechanical strength of the biological tissues, and thus greatly hindering three-dimensional imaging on the expanded biological tissues. Meanwhile, due to the quenching of endogenous fluorescence, the expanded tissues prepared with conventional methods must be fluorescently stained again before imaging, thus greatly reduce the throughput.

In order to overcome the above shortcomings of the existing biological tissue expansion technologies, a novel and rapid biological tissue clearing and expansion method (CMAP) was developed. Biological tissue clearing and expansion using CMAP consists of a unique procedure including fixation, clearing, monomer incubation, polymerization and expansion in sequence. Compared with previous biological tissue expansion methods, CMAP avoids the sample processing step, such as the heating and enzymatic digestion, that causes fluorescence quenching and damages to the biological tissue. Therefore CMAP is not only more rapid, but also has higher endogenous fluorescent protein retention rate, and maintains the mechanical strength of biological tissues better after expansion. In some embodiments, this method also enables expansion ratio adjustment by changing the monomer composition.

In the present invention, the biological tissue may be a biological tissue selected from the group consisting of a brain, a spinal cord, a lung, a kidney, a spleen, a heart, etc., and the biological tissue sample may be the whole or a part of the above tissues. The organism may be one or more species selected from biological research model animals. The biological research model animal may be, for example, a nematode, a zebrafish, a planarian, a fruit fly, an Xenopus, a salamander, a mouse, a rabbit, a pig, a monkey, etc. Alternatively, the organism may be a vertebrate, including a mammal, a reptile, a bird, and the like. The mammal may be, for example, a human, a mouse, a rabbit, a pig, a monkey, etc.

The invention provides a clearing and expansion method for a biological tissue, comprising:
(1) biological tissue sample delipidation: delipidation a fixed biological tissue sample;
(2) monomer incubation and permeating: incubating the delipidated biological tissue sample in a gel monomer solution to allow the monomer molecules to permeate into the degreased biological tissue sample;
(3) polymerization: initiating polymerization of the monomer molecules that permeate into the biological tissue sample to form a polymer gel;
(4) expansion: placing the gelled biological tissue sample into water for expansion.

In step (1) of biological tissue sample delipidation (sometimes also called degreasing), the fixation of the biological tissue sample is not particularly limited, and any fixation method applicable in this field may be used. For example, paraformaldehyde (e.g., a 4% solution of paraformaldehyde) may be used to fix the freshly taken biological tissue sample.

In step (1) of biological tissue sample delipidation, the delipidation method is not particularly limited. The delipidation may be performed by using a delipidation method selected from the hydrophilic clearing methods represented by CUBIC methods, for example, by using the CUBIC-L delipidation solution, the delipidation reagent in CN202110879793.9, and the like, but it is not limited thereto.

In some embodiments, the delipidation is performed by using a delipidation reagent that is an aqueous solution containing, by mass percentage concentration, about 5 to 15% of N-butyldiethanolamine and about 5 to 15% of Triton X-100. Preferably, in the delipidation reagent, the weight ratio of N-butyldiethanolamine to Triton X-100 is about 1:0.8 to 1.2, preferably about 1:1. In particular, the degreasing reagent is an aqueous solution containing, by mass percentage concentration, about 10% of N-butyldiethanolamine and about 10% of Triton X-100. In the case that the degreasing reagent is used, the stability of endogenous fluorescent protein molecules can be maintained with high lipolytic ability {Tainaka 2018}.

In some embodiments, the delipidation may be performed under shaking (e.g., on a shaker).

In some embodiments, during delipidation, the delipidation reagent may be replaced regularly or irregularly, for example, every 6 hours, every 12 hours, or every 24 hours, but the present invention is not limited thereto.

During delipidation, the amount of delipidation reagent at single use is not particularly limited as long as the biological tissue sample can be immersed. In particular, the specific amount can be determined based on the volume of the biological tissue sample. For example, the amount of the delipidation reagent at single use may be about 5 to 25 times, preferably about 10 to 20 times, especially about 15 times of the volume of the sample.

The delipidation may take 5 minutes or more, 1 hour or more, 1 day or more, etc., but is not limited thereto. The specific delipidation time may be appropriately varied according to the volume and age of the biological tissue sample, the amount of delipidation reagent, etc. For example, for a brain slice of a mouse with a thickness of 200 μm, the delipidation may be accomplished in about 10 minutes; for a whole brain and a spinal cord of an adult mouse, the delipidation may be accomplished in about 5 days.

Decolorization (heme, melanin, etc.) may also be achieved with the delipidation.

After the delipidation, the volume of the biological tissue sample may expand, for example, by about 1.3 to 1.5 times, but is not limited thereto. After the delipidation, the biological tissue becomes transparent.

Since most of lipid molecules have been removed from the delipidated biological tissue sample, in the following step (2), the gel monomer molecules are more likely to permeate into the delipidated biological tissue sample and are cross-linked with the protein molecules in the biological tissue sample.

In step (2) of monomer incubation and permeating, the delipidated biological tissue sample is immersed in a gel monomer solution, so that the monomer molecules can permeate into the delipidated biological tissue sample.

The gel monomer solution includes a gel monomer, an initiator and a solvent, but is not limited thereto.

The gel monomer is not particularly limited and may be any gel monomer used in hydrogel-based clearing methods represented by CLARITY.

In particular, the gel monomer may include one or more hydrophilic monovinyl monomers selected from acrylamide monomers, acrylic monomers, etc. and one or more hydrophilic divinyl monomers as a cross-linking reagent. The acrylamide monomer may be, for example, acrylamide (AA), N,N-dimethylacrylamide (DMAA), methacrylamide, ethylacrylamide, or isopropylacrylamide, etc., but is not limited thereto. In particular, the acrylamide monomer may be acrylamide. The acrylic monomer may be, for example, acrylic acid, methacrylic acid, ethylacrylic acid, or an alkali metal salt thereof (such as sodium acrylate (SA)), etc., but is not limited thereto. In particular, the acrylic monomer may be sodium acrylate (SA). The hydrophilic divinyl monomer may be a monomer having two monomer structures selected from the above acrylamide monomers and acrylic monomers in a molecule, for example, it may be N,N′-methylenebisacrylamide (BA), etc., but is not limited thereto.

In one embodiment, the gel monomer includes acrylamide, sodium acrylate and N,N′-methylenebisacrylamide as a cross-linking reagent.

The initiator may be a thermal initiator or a UV initiator.

The thermal initiator may be a thermal initiator capable of initiating polymerization of gel monomer molecules at 30 to 100° C. For example, the thermal initiator may be one or more selected from the group consisting of azo initiators (such as azobisisobutyronitrile (AIBN), azobisisoheptanitrile); peroxide initiators (such as ammonium persulfate and potassium persulfate), etc., but is not limited thereto.

The ultraviolet initiator may be an ultraviolet initiator that can initiate a polymerization reaction of gel monomers by irradiation with ultraviolet light in a low-temperature environment (for example, at 4° C. or lower, such as on an ice bath). For example, the UV initiator may be one or more selected from the group consisting of azo initiators, such as azobisisobutylamidine hydrochloride (AIBA), hydrochloride azobisisobutylimidazoline (AIBI, VA-044), azobiscyanopentanoic acid (ACVA, V-501), and azobisisopropylimidazoline (AIP, VA-061 initiator); aromatic carbonyl initiators, such as acetophenone initiators; light alkyl ketone initiators, etc., but is not limited thereto.

The solvent may be a PBS solution, such as an about 0.01M PBS solution.

In one embodiment, the gel monomer solution contains, in mass (g)/volume (ml) concentration, about 30% of acrylamide, about 0.1% of N,N′-methylenebisacrylamide, about 10% of sodium acrylate and about 0.5% of azobisisobutyrimidazoline hydrochloride, and the solvent is an about 0.01M PBS solution.

During the monomer incubation and permeating, the specific amount of the gel monomer solution may be determined based on the volume of the biological tissue sample. For example, the amount of the gel monomer solution may be about 5 to 20 times, preferably about 8 to 15 times, especially about 10 times of the volume of the sample.

The monomer incubation and permeating may take 5 minutes or more, 1 hour or more, 1 day or more, etc., but is not limited thereto. The specific time of the monomer incubation and permeating may be appropriately varied according to the volume and age of the biological tissue, the concentration and amount of the gel monomer solution, etc. For example, for a mouse brain slice with a thickness of 200 μm, the incubation time may be about 10 minutes; for a whole brain and a spinal cord of an adult mouse, the incubation time may be about 2 days.

After the monomer incubation and permeating, the expansion ratio of biological tissue may be reduced, or even restored to its original size and become opaque again.

At the same time, hydrogel polymers with different expansion ratios and mechanical strengths can finally be obtained by using monomer reagents with different chemical compositions. For example, the experimental results show that in a gel monomer system consisting of acrylamide (AA), N,N′-methylenebisacrylamide (BA) and sodium acrylate (SA), the expansion ratio of the biological tissue may be changed by adjusting the ratio of AA to SA in the gel monomer composition, and the mechanical strength of the expanded biological tissue may be changed by adjusting the ratio of BA. Within a certain range, the expansion ratio of the expanded biological tissue would increase as the concentration of AA or SA increases, and the mechanical strength of the sample would increase as the concentration of BA increases.

In step (3) of polymerization, a polymer gel is formed by initiating a polymerization reaction of the monomer molecules that permeate into the biological tissue.

The method of initiating the polymerization of the monomer molecules is not limited, as long as a suitable gel can be produced. The polymerization may be initiated, for example, by heating or by irradiation with ultraviolet light. By polymerization, a polymer gel with uniform structure and strength can be formed.

In some embodiments, constant temperature heating may be used to initiate the polymerization and produce a gel. At this time, the biological tissue sample after the monomer incubation and permeating may be placed in a constant temperature environment at 30 to 100° C. to initiate polymerization of the monomer molecules and obtain a polymer gel with uniform structure and strength.

In some embodiments, the polymerization may be initiated by irradiation with ultraviolet light. At this time, the biological tissue sample after the monomer incubation and permeating may be irradiated with ultraviolet light to initiate polymerization of the monomer molecules and form a polymer gel with uniform structure and strength. In particular, the polymerization initiated by ultraviolet light irradiation may be carried out in a low temperature environment, for example at 4° C. or below, for example on an ice bath. Initiating monomer polymerization with ultraviolet light in a low-temperature environment is not only faster in gel generation than the above method of polymerization initiated by constant temperature heating, but also prevents the high temperature generated during the gelling process from damaging endogenous fluorescent proteins in biological tissues, thereby providing a faster and better protection for endogenous fluorescent proteins. For example, for a mouse brain incubated in the same monomer, the constant temperature heating method needs 2 hours to complete the polymerization, but the ultraviolet light-initiated polymerization method only needs 1 minute to complete the polymerization.

The step (3) of polymerization may further include an embedding step. The embedding of the biological tissue sample may be completed simultaneously with the polymerization, that is, the gel monomer solution is added at one time until the biological tissue sample is completely covered, and then polymerization is initiated to form a gel and complete the embedding.

Alternatively, the embedding may be completed in several steps, which can also be called a multilayer biological tissue gel embedding method. The multilayer biological tissue gel embedding method includes the steps of: (1) preparing a bottom gel layer: injecting a small amount of gel monomer solution into a container to cover the bottom of the container, initiating polymerization to generate a bottom gel layer; (2) placing the biological tissue sample after the monomer incubation and permeating on the bottom gel layer in the container, and injecting the gel monomer solution into the container until the biological tissue sample is completely covered; and (3) initiating polymerization to form a gel layer and complete the embedding. The biological tissue is embedded into a gel with the same composition while completing the polymerization of the biological tissue by performing the gel embedding step by step, which can facilitate three-dimensional imaging on the obtained expanded biological tissue sample using a fluorescence microscope.

FIG. 2 shows a multilayer biological tissue gel embedding method according to one embodiment, wherein \textcircled{1} preparing a gel container; \textcircled{2} sealing the bottom of the gel container with a nano-tape; \textcircled{3} injecting a small amount of gel monomer solution into the container to cover the bottom of the container and initiating polymerization with ultraviolet light to form a bottom gel layer; \textcircled{4} placing the biological tissue sample after the monomer incubation and permeating on the bottom gel in the container; \textcircled{5} injecting the gel monomer solution into the container until the biological tissue sample is completely covered; \textcircled{6} covering the upper part of the gel container with a coverslip; \textcircled{7} initiating polymerization with ultraviolet light; \textcircled{8} forming a gel; \textcircled{9} taking out the gel-embedded biological tissue.

Since the biological tissue sample has been delipidated, there is no need to perform protein denaturation on the biological tissue sample after the biological tissue sample is gel-embedded according to the method of the present invention, thereby further protecting the endogenous fluorescent proteins in the biological tissue sample.

In step (4) of expansion, the gel-embedded biological tissue sample is placed in water for expansion. The electrostatic repulsive force between the anions in the gel causes the gel to expand isotropically, and finally a transparent and expanded hydrogel protein molecular complex with a uniform refractive index and certain mechanical strength is obtained.

In some embodiments, the expansion may be performed under shaking (e.g., on a shaker).

In some embodiments, water may be replaced regularly or irregularly during the expansion, for example, every 6 hours, every 12 hours, or every 24 hours, but the present invention is not limited thereto.

During the expansion, the amount of water at single use is not particularly limited as long as the gel sample can be immersed. In particular, the specific amount may be determined based on the volume of the gel sample. For example, the amount of water at single use may be about 10 to 1000 times, preferably about 100 to 500 times, especially about 200 times of the volume of the gel sample.

There is no particular limitation on the expansion time, as long as the biological tissue sample is fully expanded and a biological tissue sample with a refractive index close to water is finally obtained. Generally, the expansion time may be 30 minutes or more, 1 hour or more, 2 hours or more, etc., but is not limited thereto. There is no upper limit on the expanding time, but an excess time would increase time and equipment costs. Generally, the expansion time may be 5 days or less, 4 days or less, 3 days or less, 48 hours or less, etc. The specific expansion time may be appropriately varied according to the volume and age of the biological tissue sample, the amount of water used, etc. For example, for a mouse brain slice with a thickness of 200 μm, complete expansion may be accomplished in about 120 minutes; for a whole brain and a spinal cord of an adult mouse, complete expansion may be accomplished in about 2 days.

The clearing and expansion method for a biological tissue according to the present invention is applicable to both an endogenous fluorescent protein-labeled biological tissue and an immunofluorescence-labeled biological tissue.

Therefore, in some embodiments, the clearing and expansion method for a biological tissue according to the present invention further includes a step of performing fluorescent staining after step (1) of delipidation the biological tissue sample.

The method for performing fluorescent staining is not particularly limited, and any suitable immunofluorescent staining or other staining method in the art can be used to fluorescent-label biological tissues. Therefore, for a biological tissue that needs to be immunofluorescent-labeled, the biological tissue can be fluorescent-labeled according to the corresponding immunofluorescent labeling procedures of the biological tissue after the biological tissue is cleared. For example, propidium iodide (PI, sigma-P4170-25 MG) can be used to label cell nuclei in a biological tissue sample after the biological tissue sample is delipidated.

FIG. 1 is a schematic flow chart for preparing transparent and expanded whole mouse brain (A) and whole spinal cord (B) samples according to the method of the present invention, which mainly includes the steps of: (1) colleting a biological tissue sample; (2) fixing the biological tissue sample with an about 4% paraformaldehyde solution; (3) delipidation (decoloring) the biological tissue sample; (4) optionally staining the biological tissue sample; (5) performing monomer incubation and permeating on the biological tissue sample; (6) polymerizing the biological tissue sample, for example, placing the container on ice and irradiating it with ultraviolet light, optionally performing embedding at the same time; (7) expanding the gelled biological tissue sample in ionized water.

In yet another aspect, the present invention provides a method for imaging a biological tissue sample, the method comprising:
processing a biological tissue sample by the clearing and expansion method for a biological tissue according to the present invention;
imaging the processed biological tissue sample.

There is no particular limitation on the imaging, and any suitable imaging system can be used according to the corresponding imaging process. For example, the biological tissue sample is fixed on a sample holder of a microscope for imaging.

The present invention has been described in detail above, but the above embodiments are only illustrative in nature and are not intended to limit the present invention. Furthermore, the present invention is not bound by any theory presented in the preceding prior art or summary of the invention or the following examples.

In the present description, all features or conditions defined in the form of numerical ranges or percentage ranges are for brevity and convenience only. Accordingly, descriptions of numerical ranges or percentage ranges shall be deemed to cover and specifically disclose all possible subranges and individual values within the ranges.

In the present description, a numerical value shall be understood to have an accuracy of the significant digits of the numerical value, provided that the object of the invention is achieved. For example, the number 40.0 should be understood to cover the range from 39.50 to 40.49. With the exception of the working examples provided at the end of the detailed description, all numerical values for parameters (e.g., quantities or conditions) in the present application documents (including the appended claims) are to be understood in all cases as being modified by the term “about”, regardless of whether “about” actually appears before the value. “about” means that the stated value is allowed to be slightly less precise (somewhere near exact at the value; about or reasonably close to the value; about). If the imprecision provided by “about” is not understood in this ordinary sense in the art, “about” as used herein at least means the variation that can be produced by ordinary methods of measuring and using these parameters. For example, “about” may include variations of less than or equal to 10%, less than or equal to 5%, less than or equal to 4%, less than or equal to 3%, less than or equal to 2%, less than or equal to 1%, or less than or equal to 0.5%, and in some respects, a variation of less than or equal to 0.1%.

The above description is intended to be illustrative rather than restrictive. For example, the above-described embodiments (or one or more features thereof) may be used in combination with each other. For example, those of ordinary skill in the art may use other embodiments upon reading the above description. Additionally, in the detailed embodiments above, various features may be grouped together to simplify the present disclosure. This should not be interpreted as an intention that an unclaimed disclosed feature is essential to any claim. Rather, the subject matter of the present disclosure may have features less than all features of a particular disclosed embodiment. Thus, the claims are hereby incorporated into the detailed embodiments as examples or embodiments, with each claim standing on its own as a separate embodiment, and it is contemplated that these embodiments may be combined with one another in various combinations or permutations. The scope of the disclosure should be determined with reference to the appended claims, along with the full scope of equivalents of these claims.

### Beneficial Effects

The clearing and expansion method for a biological tissue according to the present invention can obtain a transparent and expanded biological tissue with a uniform refractive index by unique sample processing procedures including fixing, clearing, (optional) staining, monomer solution incubation, gel embedding and expansion on a biological tissue sample, and overcomes the shortcomings of existing methods. The process for processing a biological tissue according to the clearing and expansion method for a biological tissue of the present invention and the functions of each step in the process are shown in FIG. 1 below, where A and B are the processes for processing a whole brain and a whole spinal cord of a mouse, respectively.

Different from the existing biological tissue expansion technologies, the clearing and expansion method for a biological tissue according to the present invention performs clearing before monomer permeation of the biological tissue, thus avoiding the protein denaturation operations such as heating, detergent treatment, or enzymatic digestion on the biological tissue which are needed after monomer permeation in other expansion technologies, and effectively preserve the endogenous fluorescent proteins in biological tissues. At the same time, in the clearing and expansion method for a biological tissue according to the present invention, a gel polymerization of the monomer molecules is initiated by irradiating the biological tissue placed in a low-temperature environment with ultraviolet light after monomer permeation, thereby further avoiding the damage to endogenous fluorescent proteins which other expansion technologies may cause during initiating a gel reaction at high temperature. Therefore, compared with the existing biological tissue expansion technologies, the clearing and expansion method for a biological tissue according to the present invention has the advantages such as high retention rate of endogenous fluorescent protein, short sample preparation time, and high mechanical strength of the expanded biological tissue, etc. In addition, the clearing and expansion method for a biological tissue according to the present invention can also adjust the expansion ratio of the biological tissue by adjusting the components in the gel monomer solution. These advantages of the clearing and expansion method for a biological tissue according to the present invention greatly facilitate the three-dimensional imaging on large-volume, multi-cellular biological tissues using fluorescence microscopy at submicron to nanometer spatial resolution.

### BRIEF DESCRIPTION OF THE DRAWINGS

FIG. 1 is a schematic flow chart for preparing transparent and expanded whole mouse brain (A) and whole spinal cord (B) samples according to the method of the present invention.

FIG. 2 is a schematic flow chart of the multilayer biological tissue gel embedding method according to the method of to the present invention.

FIG. 3 shows the process of clearing and expansion of a whole mouse brain in Example 1 according to the method of the present invention and the morphology in each step of the process. Scale bar: 5 mm.

FIG. 4 shows the process of clearing and expansion of a mouse spinal cord in Example 2 according to the method of the present invention and the morphology in each step of the process. Scale bar: 5 mm.

FIG. 5 shows the comparison of the preservation of the endogenous fluorescent proteins in mouse tissues processed according to the CMAP method of the present invention and the MAP method in the prior art. Scale bar: 5 mm.

FIG. 6 shows the morphologies of a whole adult Thy1-eGFP mouse brain in each step through the clearing and expansion processing using the CMAP with different gel monomer solutions. Scale bar: 5 mm.

FIG. 7 shows the three-dimensional imaging results of the hippocampus region of the expanded Thy1-eGFP mouse brain, where (A) the three-dimensional imaging result of a 9×11×5 mm³ volume in the hippocampus of the expanded Thy1-eGFP mouse brain; (B) The axial projection of the imaging area shown in A; (C,D) three-dimensional imaging results of two 2×2×5 mm³ areas marked in A; (E-G) a cross-sectional view of the XY transverse section shown in Fig. C; (H-J) a cross-sectional view of the XY transverse section shown in Fig. D; (K, L) a cross-sectional view of the XZ axial section shown in Figs. C and D; (M-P) enlarged views of selected areas in Figs. E-G and K; (Q-T) enlarged views of selected areas in Figs. H-J and L. Scale bars: 1 mm (A), 200 μm (E, K), 50 μm (M).

FIG. 8 shows the three-dimensional imaging result of the local area of an expanded mouse spinal cord, where A shows the three-dimensional imaging results of a 9×8×3 mm³ area of the expanded mouse spinal cord; B shows a cross-sectional view of the section shown in A; C-F show partial enlarged views of the areas shown in B.

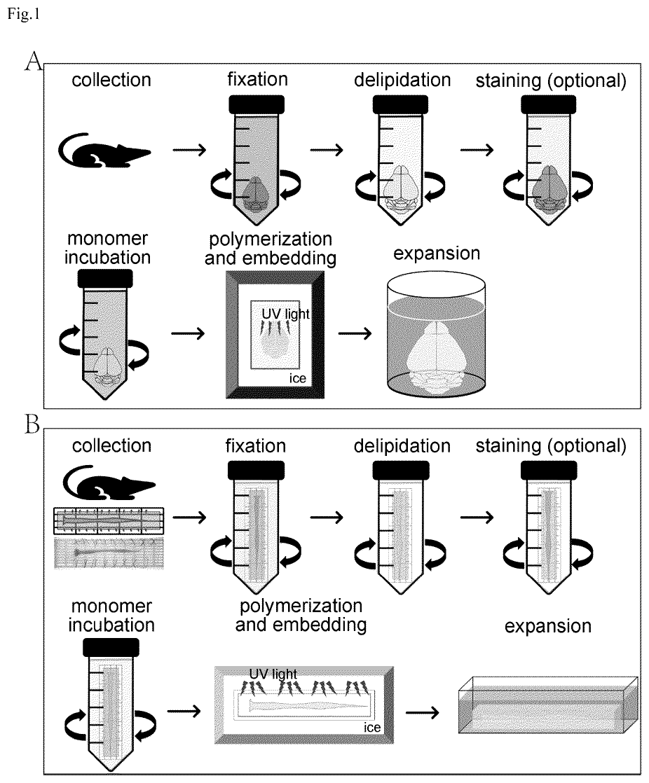

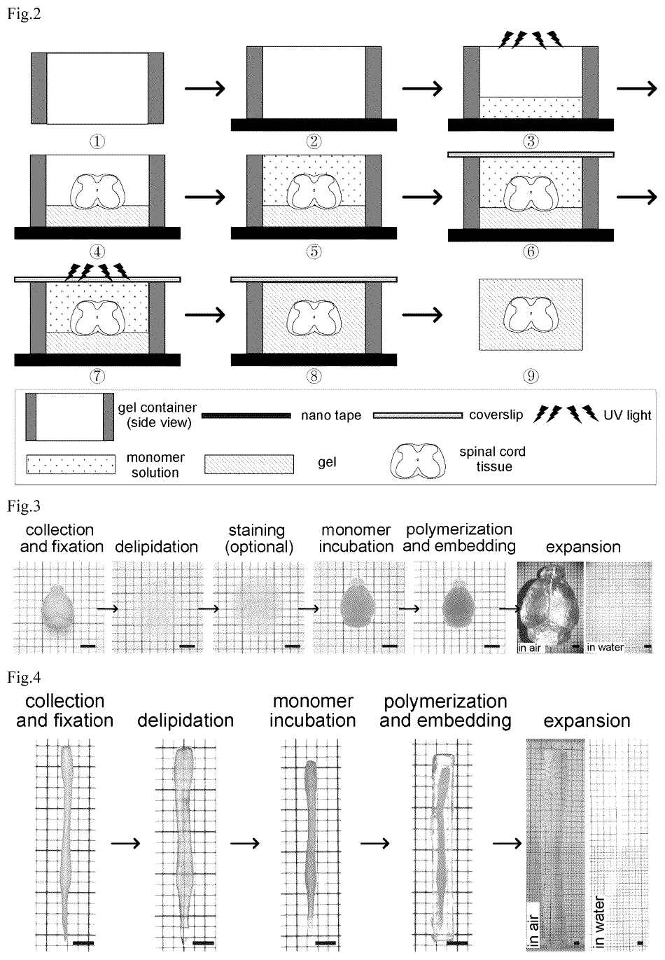

### DETAILED EMBODIMENTS

In the following, the following examples are provided for a better understanding of the present invention. However, the following examples are provided only for easier understanding of the present invention, and the scope of the present invention is not limited thereto. Furthermore, the present application is not bound by any theory presented in the preceding prior art or summary of the invention or the following examples. Unless otherwise stated, the methods, reagents and conditions used in the examples are conventional methods, reagents and conditions in the art.

### Materials and Methods

### 1. Materials

Sodium chloride (NaCl, Sangon Biotech-A610476), potassium chloride (KCl, Sangon Biotech-A100395), potassium dihydrogen phosphate (KH₂PO₄, Sangon Biotech-A100781), disodium hydrogen phosphate dodecahydrate (Na₂HPO₄·12H₂O, Sangon Biotech-A607793-0500), concentrated hydrochloric acid (HCl, Sinopharm-10011008), pentobarbital sodium, heparin sodium (Sangon Biotech-A603251), sodium hydroxide (NaOH, Sinopharm-10019718), paraformaldehyde (PFA, sigma-1058357), Triton X-100 (Sangon Biotech-A110694-9001), N-butyldiethanolamine (TCI-B0725-500ML), acrylamide (AA, Sangon Biotech-A100341-0500), Bis Acrylamide (BA, Sigma-274135-100ML), sodium acrylate (SA, MACKLIN-S833838-100G), 2,2′-Azobis [2-(2-imidazolin-2-yl) propane] dihydrochloride (VA-044, HAWN-R008695), sodium dodecyl sulfonate (SDS, sigma-V9008590), tris(hydroxymethyl)aminomethane (Tris, sigma-50046).

### 2. Preparation of Reagents

### 1. 0.01M PBS

8 g of sodium chloride (NaCl), 0.2 g of potassium chloride (KCl), 1.44 g of Na₂HPO₄, and 0.24 g of KH₂PO₄ were dissolved in 900 ml of double-distilled water (dd H₂O), the resulting solution was adjusted to a pH of 7.4 and brought to a volume of 1 liter. Then the prepared solution was sterilized with high pressure steam and stored at room temperature.

2. 4% paraformaldehyde (S1)

40 g of paraformaldehyde (PFA) was added to 900 ml of 0.01M PBS, and a small amount of sodium hydroxide was added thereto under stirring to promote the dissolution of PFA. After the PFA was completely dissolved, concentrated hydrochloric acid was added dropwise to adjust the pH to 7.4, and 0.01M PBS was added to bring the volume to 1 L. 4% PFA can be stored at 4° C. for 1 month and it is recommended to prepare it fresh before use.

### 3. Delipidation Solution (Clearing Solution, CS)

100 g of N-butyldiethanolamine and 100 g of Triton were dissolved in 800 g of dd H₂O. After
the solute was completely dissolved under stirring at room temperature, the resultant was defoamed. The prepared reagent can be stored at 20° C. for 1 month.

### 4. Gel Monomer Solution (Monomer Solution, MS).

30 g of acrylamide, 0.1 g of N,N′-methylenebisacrylamide, 10 g of sodium acrylate and 0.5 g of azobisisobutyrimidazoline hydrochloride were added into 90 ml of 0.01M PBS, and sonicated in ice water to completely dissolve the solute. Then 0.01M PBS was added dropwise to bring the volume to 100 ml. Then, the resultant was centrifuged with a centrifuge at 1000 rpm for 5 minutes, and the supernatant was stored at 4° C.

5. MAP-Related Reagents were Prepared with Reference to {Ku, 2016}.

MAP perfusion reagent I: 4 g of acrylamide, 0.05 g of N,N′-methylenebisacrylamide, and 0.8 g of sodium acrylate were added into 90 ml of 0.01M PBS, and stirred on ice until they were completely dissolved, and the resulting solution was brought to a volume of 100 ml by dropwise addition of 0.01M PBS. Then the resultant was centrifuged at 1000 rpm for 3 minutes, and the transparent supernatant was stored at 4° C. in the dark. The solution was prepared for immediate use.

MAP perfusion solution II: 30 g of acrylamide, 0.1 g of N,N′-methylenebisacrylamide, 10 g of sodium acrylate, 0.1 g of azobisisobutyrimidazoline hydrochloride and 4 g of paraformaldehyde were added into a container containing 90 ml of 0.01M PBS, stirred on ice until the solutes were completely dissolved, and brought to a volume of 100 ml by dropwise addition of 0.01M PBS. Then the solution was centrifuged at 1000 rpm for 3 minutes, the transparent supernatant was stored at 4° C. in the dark. The solution was prepared for immediate use.

MAP tissue denaturation reagent: 57.7 g of sodium dodecyl sulfonate, 11.7 g of sodium chloride, and 6.1 g of tris(hydroxymethyl)aminomethane were added into 900 ml of ddH₂O, and heated under stirring (30° C.) until they were completely dissolved. The resulting solution was adjusted to pH 9.0 with concentrated hydrochloric acid, and brought to a volume of 1 L by dropwise addition of ddH₂O. The prepared solution was stored at room temperature.

### Example 1 Clearing and Expansion of a Whole Adult Mouse Brain

The procedure and specific operations for clearing and expanding a biological tissue by the biological tissue clearing and expansion method (CMAP) according to the present invention will be further described in detail using clearing and expansion of a whole brain of an adult Thy1-eGFP mouse labeled with endogenous fluorescent proteins as an example.

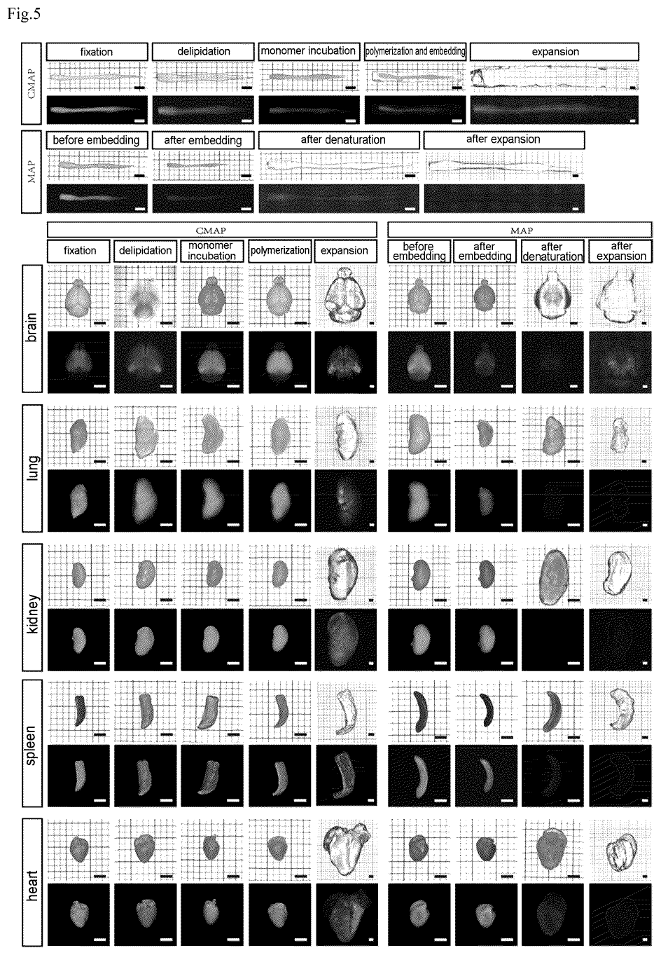

As shown in the flow chart of FIG. 3, a whole mouse brain was cleared and expanded, and the morphology of the whole mouse brain after each step through the procedure are shown. Scale bar: 5 mm.

### 1. Collection and Fixation of the Whole Mouse Brain (1.5 Days)

a. the mouse (male, 3 months old) was deeply anesthetized by intraperitoneal injection of a 2% sodium pentobarbital (150 mg/kg).
b. the mouse was cardiacally perfused in sequence with 10 ml of a pre-cooled 0.01 M PBS (pH 7.4) containing 10 U/ml heparin sodium and 25 ml of a pre-cooled S1.
c. the whole mouse brain was collected by dissection, immersed in a centrifuge tube containing 40 ml of S1, and placed on a shaker at 4° C. for 18 hours for fixation.
d. the next day, the sample was washed three times with 0.01 M PBS for two hours each time to completely remove the residual S1 and obtain a fixed sample.

### 2. Delipidation (Decoloring) of the Whole Mouse Brain (5 Days)

The fixed whole mouse brain was immersed in a container containing 40 ml of the delipidation reagent CS, and placed on a shaker at 37° C. for delipidation and decolorization. A fresh delipidation reagent CS was replaced every 2 days until the whole mouse brain was completely transparent. The degreased whole mouse brain was uniformly transparent, and the size of the cleared sample expanded to approximately 1.5 times of its original size in each direction.

3. Immunofluorescence Staining (1 day)

Nuclei in the mouse brain were labeled using PI (sigma-P4170-25 MG). The staining was carried out at 37° C. for 1 day by adding an aqueous PI solution (final concentration: 10 μg/ml) to the whole mouse brain clearing reagent CS. This step could be performed simultaneously with the delipidation step, the dye was added directly to the delipidation reagent on the last day of the delipidation; or it could be performed separately after the delipidation.

### 4. Incubating in a Monomer Solution (2 Days)

The delipidated and stained whole mouse brain was immersed into a centrifuge tube containing 15 ml of a gel monomer solution, and placed on a shaker at 4° C. for 2 days to allow the monomer solution to fully permeate into the mouse brain tissue. After incubating in the monomer solution, the mouse brain returned to its original size and became opaque again.

5. Polymerization (without Embedding) (10 Minutes)
a. the monomer-incubated sample was placed on a 60 mm Petri dish and the Petri dish was placed on ice.
b. the sample was irradiated continuously using ultraviolet light (5w) for about 1 minute to initiate polymerization of the monomer molecules that had penetrated into the mouse brain.

### 6. Expansion (2 Days)

The polymerized mouse brain was placed into a container containing a sufficient amount of deionized water (pH 9.5). The container was placed in a shaker at 20° C. to allow the mouse brain to expand evenly. During this period, fresh deionized water (pH 9.5) was replaced every 12 hours until the mouse brain was fully expanded. After this step, a transparent, expanded mouse brain with a refractive index close to that of water and good mechanical strength was obtained.

### Example 2. Clearing and Expansion of an Adult Mouse Spinal Cord

The procedure and specific operations for clearing and expanding a biological tissue by the biological tissue clearing and expansion method (CMAP) according to the present invention will be further described in detail using clearing and expansion of an adult Thy1-eGFP mouse spinal cord labeled with endogenous fluorescent proteins as an example.

As shown in the flow chart of FIG. 4, an adult mouse spinal cord was cleared and expanded, and the morphologies of the mouse spinal cord after each step through the procedure are shown. Scale bar: 5 mm.

### 1. Collection and Fixation of the Mouse Spinal Cord (1.5 Days)

a. the mouse (male, 3 months old) was deeply anesthetized by intraperitoneal injection of a 2% sodium pentobarbital (150 mg/kg).
b. the mouse was cardiacally perfused in sequence with 10 ml of a pre-cooled PBS (pH 7.4) containing 10 U/ml heparin sodium and 25 ml of a pre-cooled 4% paraformaldehyde (pH 7.4).
c. the spinal cord of the mouse was collected by dissection, fixed between a POM polyformaldehyde hole plate and a 100-mesh nylon mesh (to ensure that the spinal cord would not bend during post-fixation and PFA could fully contact the sample), soaked in a centrifuge tube containing 40 ml of S1, and placed on a shaker at 4° C. for 18 hours for fixation.
d. the next day, the sample was washed three times with 0.01 M PBS for two hours each time to completely remove the residual S1 and obtain a fixed sample.

### 2. Delipidation (Decolorization) of the Mouse Spinal Cord (5 Days)

The sample was immersed into a centrifuge tube containing 40 ml of the delipidation reagent CS, and placed on a shaker at 37° C. for delipidation and decolorization. A fresh CS was replaced every 2 days until the mouse spinal cord was completely transparent. The delipidated mouse spinal cord was uniformly transparent, and the size of the cleared sample expanded to approximately 1.5 times of its original size in each direction.

### 3. Immunofluorescence Staining

Nuclei in the mouse spinal cord were labeled using PI (sigma-P4170-25 MG). The staining was carried out at 37° C. for 1 day by adding an aqueous PI solution (final concentration: 10 μg/ml) to the mouse spinal cord delipidation reagent CS. This step could be performed simultaneously with the delipidation step, the dye was added directly to the delipidation reagent on the last day of the delipidation; or it could be performed separately after the delipidation.

### 4. Incubation in a Gel Monomer Solution (2 Days)

After delipidation and staining, the mouse spinal cord was immersed in a container containing a gel monomer solution. The container was placed on a shaker at 4° C. for incubation for 2 days to allow the monomer solution to fully permeate into the spinal cord tissue. After the incubation in the gel monomer solution, the mouse spinal cord restored to its original size and became opaque.

### 5. Polymerization and Embedding (20 Minutes)

Multilayer polymerization and embedding were carried out on the monomer-soaked mouse spinal cord using a mold that matched the volume and shape of the mouse spinal cord.

An appropriate amount of the gel monomer solution MS was added to cover the bottom of the mold to a depth of 1 to 2 mm, irradiated with ultraviolet light (5 W) for 30 seconds to initiate polymerization of the gel monomer molecules, forming a viscous but incompletely solidified gel layer.

The mouse spinal cord incubated in the above step 4 was placed flatly on the semi-solidified gel layer in the mold, and then a sufficient amount of the gel monomer solution MS was added until it covered the mouse spinal cord and filled the entire mold. Air bubbles were removed from the gel solution by letting it stand still.

The upper surface of the mold was covered with a cover slip. Ensure there was no air gap between the cover slip and the monomer solution in the mold.

The gel mold was placed on ice, and the spinal cord sample and the monomer solution in the mold were irradiated with ultraviolet light (5 W) continuously for about 1 minute to initiate polymerization of the gel monomer molecules to complete the polymerization and embedding of the spinal cord.

### 6. Expansion.

The gel-embedded mouse spinal cord was peeled from the mold and placed in a container containing sufficient amount of deionized water (pH 9.5). The container was placed on a shaker at 20° C. to allow the mouse spinal cord to expand evenly. During this period, fresh deionized water (pH 9.5) was replaced every 12 hours until the mouse spinal cord was fully expanded. Finally, a transparent and expanded mouse spinal cord with a refractive index close to that of water and good mechanical strength was obtained.

### Comparative Example 1 Clearing and Expansion of a Whole Brain of an Adult Mouse

A whole brain of an adult Thy1-eGFP mouse was processed as below according to the procedure (MAP method) introduced in the literature {Ku, 2016}.

The procedures for MAP processing of the whole brain of the adult mouse were as follows:

### 1. Collecting, Fixing and Gel Embedding of the Whole Mouse Brain

a. an adult mouse (male mice, 3 months old) was deeply anesthetized with sodium pentobarbital (150 mg/kg).
b. the mouse was cardiacally perfused in sequence with 10 ml of the pre-cooled MAP perfusion reagent I and 25 ml of the pre-cooled MAP perfusion reagent II at a speed of 10 ml/min.
c. the whole mouse brain was dissected and placed in a centrifuge tube containing 20 ml of the MAP perfusion reagent II.
d. the centrifuge tube was placed and incubated on a shaker at 4° C. for 2 days, and then incubated on a shaker at room temperature for 24 hours to ensure uniform chemical diffusion and reaction throughout the sample.
e. the tissue was incubated using Easy-Gel (LifeCanvas Technologies, tissue gel hybridization system) under nitrogen at 45° C. for 2 hours to form a gel.

### 2. Tissue Denaturation

a. the gel-embedded tissue was placed into a centrifuge tube containing 50 ml of the MAP tissue denaturation reagent, and incubated on a shaker at 37° C. overnight.
b. the sample was transferred to EasyClear (LifeCanvas Technologies) and incubated at 70° C. for 2 days and then at 95° C. for 1 day.

### 3. Expansion

The denatured tissue was placed into 100 ml of deionized water and incubated on a shaker at room temperature for 48 hours, with the deionized water replaced every 3-5 hours.

### Comparative Example 2 Clearing and Expansion of an Adult Mouse Spinal Cord

A spinal cord of an adult Thy1-eGFP mouse was processed as below according to the procedure (MAP method) introduced in the literature {Ku, 2016}.

The procedure for MAP processing of the spinal cord of the adult mouse were as follows:

### 1. Collecting, Fixing and Gel Embedding of the Mouse Spinal Cord.

a. an adult mouse (male, 3 months old) was deeply anesthetized with sodium pentobarbital (150 mg/kg).
b. the mouse was cardiacally perfused sequentially with 10 ml of the pre-cooled MAP perfusion reagent I and 25 ml of the pre-cooled MAP perfusion reagent II (4% PFA, 30% AA, 0.05% BA, 5% SA, and 0.1% VA-044) at a speed of 10 ml/min.
c. the whole spinal cord of the mouse was dissected and placed in a centrifuge tube containing 20 ml of the MAP perfusion reagent II.
d. the centrifuge tube was placed on a shaker at 4° C. and fixed for 48 hours to obtain a fixed sample of the whole spinal cord of the mouse, making sure uniform chemical diffusion and reaction in the entire sample.
e. the tissue was incubated using Easy-Gel (LifeCanvas Technologies, tissue gel hybridization system) under nitrogen at 50° C. for 2 hours to form a gel.

### 2. Tissue Denaturation

The hydrogel-embedded tissue was placed into a centrifuge tube containing 50 ml of the MAP tissue denaturation reagent, and incubated at 70° C. for 24 hours and then at 95° C. for 12 hours.

### 3. Expansion

The denatured tissue was placed into 100 ml of deionized water and incubated on a shaker at room temperature for 36 hours, with the deionized water replaced every 3-5 hours.

### Examples 3-6 Clearing and Expansion of Lung, Kidney, Spleen, and Heart of an Adult Mouse

A B6-zsGreen mouse was used, and the lung, kidney, spleen, and heart of the adult mouse were cleared and expanded in the same manner as that in Example 1.

### Comparative Examples 3-6 Clearing and Expansion of Lung, Kidney, Spleen, and Heart of an Adult Mouse

A B6-zsGreen mouse was used, and the lung, kidney, spleen, and heart of the adult mouse were cleared and expanded in the same manner as that in Comparative example 1.

The morphologies of the biological tissues processed in Examples 1 to 6 according to the CMAP method of the present invention and Comparative Examples 1 to 6 according to the MAP method in the literature {Ku, 2016} in each step were photographed and fluorescently imaged. The results are shown in FIG. 5.

The photos were taken by using a Zeiss fluorescence stereomicroscope (Axio Zoom.V16) in bright field with an exposure intensity of 150 ms.

Fluorescence imaging was performed by using a Zeiss fluorescence stereomicroscope (Axio Zoom.V16) in fluorescence photography with an exposure intensity of 100 ms for all tissues and organs before expansion, 3 s for the expanded whole brain and spinal cord, and 100 ms for the expanded lung, kidney, spleen and heart.

FIG. 5 shows the changes in tissue morphology and fluorescence intensity in each step during processing different tissues by using the CMAP method according to the present invention and the MAP method according to the literature {Ku, 2016}, to compare the effects of these two clearing and expansion methods on the retention of endogenous fluorescent proteins.

Experimental results show that the final sample obtained by the CMAP method retains the endogenous fluorescent proteins well, while the endogenous fluorescent proteins of the final sample obtained by the MAP method are basically quenched. Therefore, the CMAP method retains endogenous fluorescent proteins in biological tissues to a much greater extent than the other tissue expansion method MAP that uses similar gel monomer molecules.

### Example 7 Effects of Different Gel Monomer Solutions on Clearing and Expansion

Different gel monomer solutions 1 to 6 were prepared according to the above preparation method of the gel monomer solution (MS), except that the following mass to volume ratios (m/v) in Table 1 were used.

The expansion ratio was measured as follows: the whole mouse brain was photographed in bright field and its area was measured by using ImageJ software. The area of the whole brain before expansion (the whole mouse brain after fixation with paraformaldehyde) was A, and the area of the whole brain after expansion (the expanded whole brain of the mouse in water) was B, and the expansion ratio (ER)=Sqar (A/B).

Mechanical strength was measured according to the following standard: apply a pressure of approximately 20 gf on an area of 1 cm² and observe the deformation of the sample.
Strong: slight elastic deformation occurs.
Medium: relatively large elastic deformation occurs, but the sample shape recovers after the pressure is removed.
Weak: plastic deformation occurs and the sample does not return to its original shape after the pressure is removed.

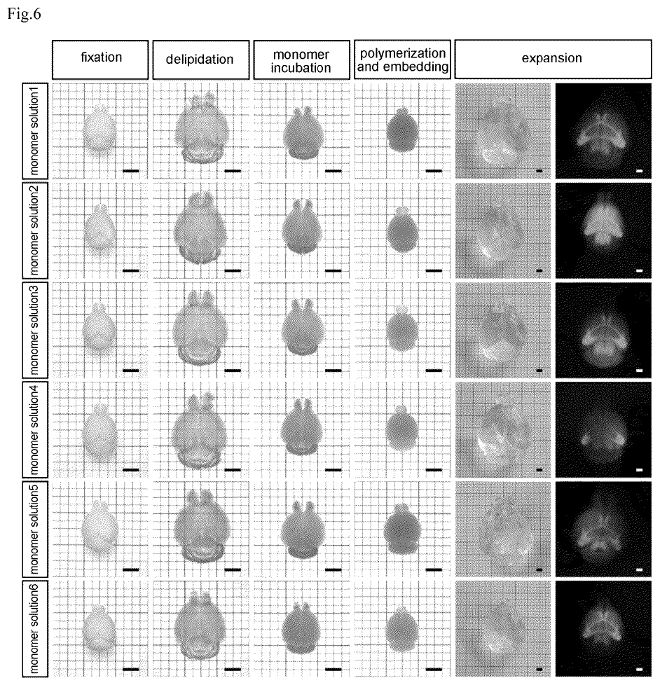

Whole brains of adult Thy1-eGFP mice were subjected to CMAP clearing and expansion in the same manner as in Example 1, except the prepared monomer solutions 1 to 6 were used, and the characteristics of the obtained expanded mouse whole brains were observed. The results are shown in Table 1 and FIG. 6.

TABLE 1
Different expansion ratios obtained by
using different gel monomer solutions.

| Monomer | AA | BA | SA | VA-044 | Expansion | Mechanical |
|---|---|---|---|---|---|---|
| solution | (m/v) | (m/v) | (m/v) | (m/v) | ratio | strength |
| Monomer | 15% | 0.05% | 10% | 0.5% | 4.01 | Medium |
| solution 1 | | | | | | |
| Monomer | 15% | 0.1% | 10% | 0.5% | 3.78 | Medium |
| solution 2 | | | | | | |
| Monomer | 30% | 0.1% | 10% | 0.5% | 3.73 | Strong |
| solution 3 | | | | | | |
| Monomer | 30% | 0.1% | 15% | 0.5% | 3.71 | Strong |
| solution 4 | | | | | | |
| Monomer | 15% | 0.1% | 7.5% | 0.5% | 3.64 | Medium |
| solution 5 | | | | | | |
| Monomer | 30% | 0.1% | 5% | 0.5% | 3.15 | Strong |
| solution 6 | | | | | | |

Experimental results show that adjusting the ratios of AA and SA in the gel monomers can change the expansion ratio of biological tissues, and adjusting the ratio of BA as a cross-linking reagent can change the mechanical strength of expanded biological tissues. Within a certain range, the expansion ratio of expanded biological tissues increases as the concentration of AA or SA increases, and its mechanical strength increases as the concentration of BA increases. Therefore, the expansion ratio and mechanical strength are the synergistic results of AA, SA and BA. The required expansion ratio and mechanical strength can be obtained by experimentally changing the ratios of AA, SA and BA.

### Example 8 Imaging

In order to examine the transparency of a biological tissue expanded by CMAP and its ability to retain endogenous fluorescent proteins, a tiling light sheet microscopy was used to perform three-dimensional imaging on a brain (Example 1) and a spinal cord (Example 2) of an adult Thy1-eGFP mouse expanded by CMAP at different spatial resolutions.

First, a sample, with a volume of 9×11×5 mm³, of the hippocampus area of the mouse brain which expanded about 5 times, was three-dimensionally imaged at a three-dimensional spatial resolution of 2×2×5 μm³ by using a 0.25 NA air objective lens, and water as the imaging buffer. Since the mouse brain expanded about 5 times, the corresponding actual spatial resolution was about 0.4×0.4×1 μm³.

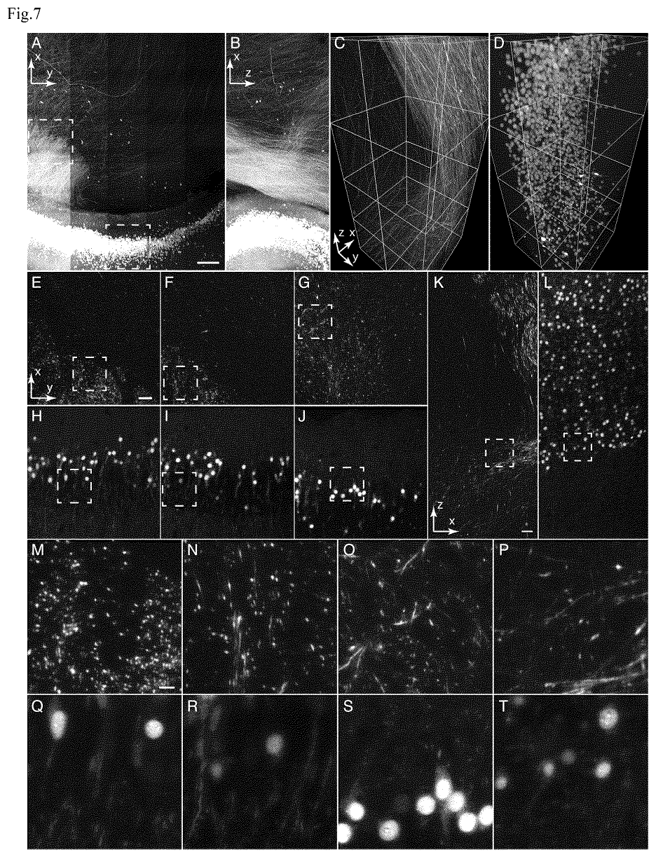

The results are shown in FIG. 7, wherein A shows the three-dimensional imaging results of the 9×11×5 mm³ area of the hippocampus area of the expanded brain of the Thy1-eGFP mouse; B shows an axial projection of the imaging area shown in A; C and D show the three-dimensional imaging results of two 2×2×5 mm³ areas marked in A; E-G show cross-sections of the XY transverse section shown in C; H-J show cross-sections of the XY transverse section shown in D; K and L show cross-sections of the XZ transverse section shown in C and D; M-P show enlarged views of selected areas in E-G and K; Q-T show enlarged views of selected areas in H-J and L. Scale bars: 1 mm (A), 200 μm (E, K), 50 μm (M).

The results in FIG. 7 show that despite the high cell density in mouse hippocampus, cellular and subcellular neuronal structures in the mouse brain, such as individual neuron axons and dendritic spines, can be clearly observed. At the same time, the expanded mouse brain tissue also has sufficient mechanical strength, such that sample deformation that may be caused during the imaging process can be effectively avoided, and the entire sample can be accurately three-dimensionally imaged.

Further, a sample with a volume of 9×8×3 mm³ of a mouse spinal cord which expanded about 4 times was three-dimensionally imaged at a three-dimensional spatial resolution of 0.6×0.6×2 μm³ by using a 0.6 NA water immersion objective and water as the imaging buffer. Since the mouse spinal cord expanded about 4 times, the corresponding actual spatial resolution was about 0.15×0.15×0.5 μm³.

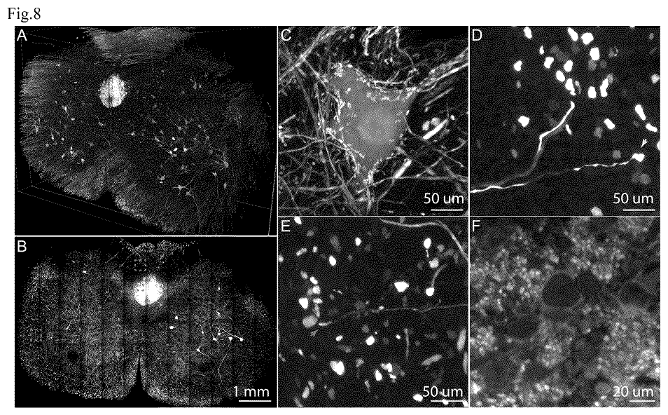

The results are shown in FIG. 8, in which A shows the three-dimensional imaging results of a 9×8×3 mm³ area of the expanded mouse spinal cord; B shows a cross-sectional view of the section shown in A; C-F show local enlarged views of the areas shown in B.

The results in FIG. 8 show that the morphology and projections of neurons of the mouse spinal cord, and synapses between the neurons can be clearly observed through the clearing and expansion and high-resolution imaging of the mouse spinal cord.

The experimental results show that, the CMAP according to the present invention not only can expand the sample and improve the three-dimensional spatial resolution at imaging, but also has good retention ability for endogenous fluorescent proteins. Biological tissues processed according to CMAP also have good transparency and mechanical strength. These advantages are of great significance for three-dimensional fluorescence imaging of biological tissues at a high resolution.

The above embodiments are only exemplary embodiments of the present disclosure and are not used to limit the present disclosure. The protection scope of the present disclosure is defined by the claims. Those skilled in the art can make various modifications or equivalent substitutions to this disclosure within the essence and protection scope of this disclosure, and such modifications or equivalent substitutions should also be deemed to fall within the protection scope of the disclosure.

### REFERENCES

Chang, J. B., et al. (2017). “Iterative expansion microscopy.” Nat Methods 14 (6): 593-599.
Chen, F., et al. (2015). “Optical imaging. Expansion microscopy.” Science 347 (6221): 543-548.
Chen, F., et al. (2016). “Nanoscale imaging of RNA with expansion microscopy.” Nat Methods 13 (8): 679-684.
Ku, T., et al. (2016). “Multiplexed and scalable super-resolution imaging of three-dimensional protein localization in size-adjustable tissues.” Nat Biotechnol 34 (9): 973-981.
Murakami, T. C., et al. (2018). “A three-dimensional single-cell-resolution whole-brain atlas using CUBIC-X expansion microscopy and tissue clearing.” Nat Neurosci 21 (4): 625-637.
K. Tainaka, T. C. Murakami, E. A. Susaki, C. Shimizu, R. Saito, K. Takahashi, A. Hayashi-Takagi, H. Sekiya, Y. Arima, S. Nojima, et al., Chemical landscape for tissue clearing based on hydrophilic reagents, Cell Rep., 24 (2018), pp. 2196-2210.e9
Tillberg, P. W., et al. (2016). “Protein-retention expansion microscopy of cells and tissues labeled using standard fluorescent proteins and antibodies.” Nat Biotechnol 34 (9): 987-992.

1. A clearing and expansion method for a biological tissue comprising:
(1) biological tissue sample delipidation: delipidate a fixed biological tissue sample;
(2) monomer incubation and permeating: incubate the delipidated biological tissue sample in a gel monomer solution to allow the monomer molecules to permeate into the delipidated biological tissue sample;
(3) polymerization: initiate polymerization of the monomer molecules that permeate into the biological tissue sample to form a polymer gel;
(4) expansion: place the polymerized biological tissue sample into water for expansion.

2. The method of claim 1, wherein, in step (1), the delipidation is performed using a delipidation reagent, which is an aqueous solution containing, by mass percentage concentration, 5 to 15% of N-butyldiethanolamine and 5 to 15% of Triton X-100.

3. The method of claim 2, wherein in the delipidation reagent, the weight ratio of N-butyldiethanolamine to Triton X-100 is 1:0.8 to 1.2.

4. The method of claim 2, wherein the delipidation reagent is an aqueous solution containing, by mass percentage concentration, 10% of N-butyldiethanolamine and 10% of Triton X-100.

5. The method of claim 1, wherein in step (2), the gel monomer solution includes a gel monomer, an initiator and a solvent.

6. The method of claim 5, wherein,
the gel monomer includes one or more hydrophilic monovinyl monomers selected from acrylamide monomers and acrylic monomers, and one or more hydrophilic divinyl monomers as a cross-linking reagent;
the initiator is selected from a thermal initiator and an ultraviolet initiator;
the solvent is a PBS solution.

7. The method of claim 6, wherein,
the acrylamide monomer is selected from the group consisting of acrylamide, N,N-dimethylacrylamide, methacrylamide, ethylacrylamide, and isopropylacrylamide;
the acrylic monomer is selected from acrylic acid, methacrylic acid, ethylacrylic acid and alkali metal salts thereof;
the hydrophilic divinyl monomer is a monomer having two monomer structures selected from the above acrylamide monomers and acrylic monomers in a molecule;
the thermal initiator is a thermal initiator that can initiate polymerization of the gel monomer molecules at 30-100° C.;
the ultraviolet initiator is selected from ultraviolet initiators that can initiate polymerization of the gel monomer by ultraviolet light irradiation at 4° C. or below.

8. The method of claim 6, wherein the acrylamide monomer is acrylamide; the acrylic monomer is sodium acrylate; and the hydrophilic divinyl monomer is N,N′-methylenebisacrylamide.

9. The method of claim 5, wherein the initiator is a UV initiator.

10. The method of claim 9, wherein the ultraviolet initiator is one or more selected from the group consisting of azo initiators, aromatic carbonyl initiators, and light alkyl ketone initiators.

11. The method of claim 9, wherein the ultraviolet initiator is one or more selected from the group consisting of azobisisobutylamidine hydrochloride, azobisisobutyrimidazoline hydrochloride, azodicyanopentanoic acid, azobisisopropyl imidazoline and acetophenone initiators.

12. The method of claim 1, wherein the gel monomer solution contains, in mass (g)/volume (ml) concentration, 30% of acrylamide, 0.1% of N,N′-methylenebisacrylamide, 10% of sodium acrylate and 0.5% of azobisisobutyrimidazoline hydrochloride, and the solvent is a 0.01M PBS solution.

13. The method of claim 1, wherein in step (2), the amount of the gel monomer solution is 5 to 20 times of the volume of the sample.

14. The method of claim 1, wherein in step (3), the polymerization is initiated by constant temperature heating or by irradiation with ultraviolet light, to produce a gel.

15. The method of claim 1, wherein the step (3) of polymerization further includes an embedding step.

16. The method of claim 15, wherein,
the embedding and polymerization are completed simultaneously, the gel monomer solution is added at one time until the biological tissue sample is completely covered, and then the polymerization is initiated to form a gel, and thus completing the embedding; or
the embedding is completed in several steps and includes the steps of: (1) preparing a bottom gel layer: injecting a small amount of gel monomer solution into a container to cover the bottom of the container, and initiating polymerization to generate a bottom gel layer; (2) placing the biological tissue sample after the monomer incubation and permeating on the bottom gel in the container, and injecting the gel monomer solution into the container until the biological tissue sample is completely covered; (3) initiating polymerization to form a gel, and completing the embedding.

17. The method of claim 1, wherein in step (4), the amount of water at single use is 10 to 1000 times of the gel sample.

18. The method of claim 1, wherein the method further includes a step of performing fluorescent staining after step (1) of delipidating the biological tissue sample.

19. A method for imaging a biological tissue sample, comprising:
processing a biological tissue sample by the method according to claim 1;
imaging the prepared biological tissue sample.
